(19) United States
(12) Patent Application Publication
(10) Pub. No.: US 2015/0328928 A1
(43) Pub. Date: Nov. 19, 2015

(54) REINFORCEMENT LAYER FOR ARTICLES MADE OF AN ELASTOMERIC MATERIAL

(71) Applicant: Continental Reifen Deutschland GmbH, Hannover (DE)

(72) Inventors: Carole Justine, Scharrel (DE); Joern Krueger, Mandelbachtal (DE); Guenter Wahl, Hohenhameln (DE); Thomas Kramer, Herford (DE)

(21) Appl. No.: 14/808,682

(22) Filed: Jul. 24, 2015

Related U.S. Application Data
(63) Continuation of application No. PCT/EP2014/051372, filed on Jan. 24, 2014.
Application No. PCT/EP2014/051372 is a continuation of application No. PCT/EP2013/076312, filed on Dec. 12, 2013.

(30) Foreign Application Priority Data
Jan. 29, 2013 (EP) 13153000.8

(51) Int. Cl. B60C 9/00

(52) U.S. Cl. CPC B60C 9/0042; B60C 2009/0035; B60C 2009/0092

(57) ABSTRACT

Reinforcement layer for articles made of an elastomeric material, preferably for vehicle tires, the reinforcement layer being rubberized and comprising a plurality of parallel reinforcements spaced apart from one another, each reinforcement including at least one twisted viscous multifilament yarn, the viscose multifilament yarn having a degree of crystallinity in the range of from 15% to 40%, a yarn count of 150 dtex to 1100 dtex and a tensile strength in the range of from 45 cN/tex to 55 cN/tex.

### CROSS REFERENCE TO RELATED APPLICATIONS

This application is a continuation application of international patent application PCT/EP2014/051372, filed Jan. 24, 2014, designating the United States and claiming priority from European application 13153000.8, filed Jan. 29, 2013 and international patent application PCT/EP2013/076312, filed Dec. 12, 2013, and the entire content of the above applications is incorporated herein by reference.

### FIELD OF THE INVENTION

The disclosure relates to a rubberized reinforcement ply for articles made of an elastomeric material, preferably for vehicle tires, wherein the reinforcement ply comprises a multiplicity of mutually spaced-apart strength members in a parallel arrangement, wherein every strength member includes at least one twisted viscose multifilament yarn. The disclosure further relates to a pneumatic vehicle tire containing this reinforcement ply.

### BACKGROUND OF THE INVENTION

Reinforcement plies for articles made of an elastomeric material such as, for example, industrial rubber products and (pneumatic) vehicle tires have the utmost importance and are common general knowledge to those skilled in the art. The reinforcement plies incorporate a multiplicity of reinforcing thread-shaped elements, which are known as strength members. These are completely embedded in elastomeric material. The strength members of these reinforcement plies have, for example, the form of woven fabrics or of calendered strength members wound in a continuous manner.

The rubberized reinforcement plies of suitable size and configuration are combined with further component parts to form an industrial rubber product or a pneumatic vehicle tire. The function of the rubberized reinforcement plies in the product in question is to reinforce the product.

Cellulose is the most frequent and significant natural, renewable and thus environmentally friendly polymer around the world. Cellulosic fibers, filaments and multifilaments are obtainable in various ways and forms, which are likewise known and familiar to those skilled in the art. The most commonly used processes are the so-called regenerated-cellulose processes wherein cellulose is first converted into soluble labile or simple-to-saponify derivatives and dissolved. Examples of soluble derivatives wherefrom cellulose is regenerable include cellulose acetate, cellulose formate and cellulose carbonate. In the most significant process, the viscose process, the labile derivative is a cellulose xanthate, and the yarns produced using the viscose process are known as viscose or rayon yarns. In the viscose process, the solution is pumped through spinneret dies, regenerated in a coagulation bath to form viscose filaments, which in one or more aftertreatment steps are washed and sized (and optionally given a functional coating) and finally either wound up on continuous-filament packages or processed into cut fiber.

A reinforcement ply as per the preamble is known, for example, from United States patent application publication 2010/0154377 A1. The strength members of this reinforcement ply comprise lyocell multifilament yarns having a fineness between 444 dtex and 10 000 dtex. A specifically exemplified multifilament yarn has a fineness of about 1670 dtex and a tenacity of about 53 cN/tex.

EP 0 908 329 B1 discloses a reinforcement ply comprising textile cords formed from synthetic multifilament yarns in PET or PEN. The textile cords are, by virtue of their construction and the yarn linear density used, comparatively thin, so the ply thickness of the rubberized reinforcement ply is comparatively low. This has the advantage that less rubber material is required for rubberizing these strength members, which results in a cost saving on materials. A thin rubberized reinforcement ply in the product, for example a vehicle tire, is further advantageous because the weight of the tire is reduced and also a lower hysteresis is caused, which has a positive effect on the rolling resistance of the tire.

High-strength cellulosic multifilament yarns of low yarn linear density are likewise known. Ultrahigh-strength yarns of low overall linear density are known to be obtainable, for example, in cellulose formate and from a formaldehyde-modified viscose process. To wit, U.S. Pat. No. 6,261,689 describes cellulose formate fibers which were conditioned at a temperature of (20±2)° C. and a relative humidity of (65±2)% in accordance with the standard atmosphere defined in EN ISO 20139 (currently: DIN EN ISO 139) and have an overall linear density of 460 dtex and a tenacity of 76 cN/tex.

U.S. Pat. No. 3,388,117 describes a formaldehyde-modified viscose process producing a viscose multifilament yarn consisting of 500 individual filaments and having an overall linear density of 485 dtex. After conditioning at 20° C. and 65% relative humidity, a tenacity of 78 cN/tex is measured, although the reported tenacity was not determined on the multifilament yarn, but on an unreported number of individual filaments taken from the multifilament. Since it is known that tenacity measured on a multifilament yarn is significantly lower than tenacity measured on a certain number of individual filaments taken from the multifilament yarn, the tenacity of the multifilament yarn described in U.S. Pat. No. 3,388,117 is significantly less than 78 cN/tex. One reason is the lower customary clamped length of 20 mm to 50 mm instead of 250 mm to 500 mm in the case of multifilament yarns. It is further known that the use of formaldehyde in the coagulation bath raises the tenacity of the viscose fibers to an extraordinary degree, so without formaldehyde the process described in U.S. Pat. No. 3,388,117 leads to a tenacity that is considerably lower than 78 cN/tex. The effect of tenacity enhancement due to the use of formaldehyde is described, inter alia, by the authors A. Kh. Khakimova, N. B. Sokolova and N. S. Nikolaeva in “Fiber Chemistry”, ISSN 157-8493, ZDB-ID 2037141X volume 1, (6.1971), pages 631 to 633. The authors referred to further write that the use of formaldehyde leads to insoluble reaction products of formaldehyde with decomposition products of the viscose. The insoluble reaction products lead to problems in the spinning bath circuit. The use of formaldehyde further has adverse consequences for the health of the manufacturing personnel. The crystallinity of this aforementioned viscose multifilament yarn, produced with formaldehyde, is 45%.

Patent document GB 685,631 does describe rayon yarns, that is, viscose multifilament yarns, consisting of 100 individual filaments and having a low overall linear density of 100 den (110 dtex), yet their conditioned tenacity is just 2.3 g/den (20.4 cN/tex) and their oven-dry tenacity is 2.9 g/den (25.6 cN/tex). GB 685,631 further exemplifies yarns having a yarn linear density of 400 den (440 dtex) with 260 filaments and moderate tenacities of 4.1 g/den (36.2 cN/tex) in the conditioned viscose multifilament yarn and 5.3 g/den (46.8 cN/tex) in the oven-dry viscose multifilament yarn.

Environmental concerns are driving efforts to use natural, renewable and environmentally caringly treated raw materials in industrial rubber products and (pneumatic) vehicle tires and also to provide corresponding reinforcement plies for the aforementioned products. These shall further reduce the rolling resistance of the pneumatic vehicle tire comprising these reinforcement plies.

### SUMMARY OF THE INVENTION

The problem addressed by the disclosure is therefore that of providing such a reinforcement ply for articles made of an elastomeric material as is comparatively thin and has been made and treated in an environmentally friendly manner. The physical properties of such a reinforcement ply shall be in an optimum range for application in the industrial rubber product or pneumatic vehicle tire.

The problem addressed by the disclosure is further that of providing a pneumatic vehicle tire made in an environmentally friendly manner and having a comparatively low rolling resistance.

The problem is solved in respect of the reinforcement ply when the viscose multifilament yarn has a crystallinity in the range from 15% to 40% and after conditioning in a DIN EN ISO 139-1:2005 standard atmosphere has a yarn linear density in the range of 150 dtex to <1100 dtex and a tenacity of 45 cN/tex to 55 cN/tex.

The reinforcement ply created, the strength members of which comprise viscose multifilament yarns treated in an environmentally friendly manner, is comparatively thin. Rubberized reinforcement plies in a tire hitherto had to utilize comparatively thick strength members of viscose/rayon multifilament yarn having a high yarn linear density in order to obtain the necessary tenacity for this application. Just how surprising the viscose multifilament yarn of the present disclosure is to those skilled in the art is shown by the fact that not even the inventors can explain why the viscose multifilament yarn of the present disclosure—combining a yarn linear density in the range of ≧150 dtex to <1100 dtex with a crystallinity in the range from 15% to 40%—should have a ≧45 cN/tex to ≦55 cN/tex tenacity as measured on the viscose multifilament yarn. Every filament of the multifilament yarn preferably has a round cross section or a granular cross section. An aforementioned reinforcement ply comprising strength members is very useful in industrial rubber products, in particular (pneumatic) vehicle tires.

The environmentally friendly reinforcement ply of the present disclosure has in particular the breaking strength, tenacity, elastic modulus, fatigue resistance and elongation at break to meet the requirements for application in a vehicle tire in particular.

In the context of the present disclosure, the term “conditioned” is to be understood as meaning that the viscose multifilament yarn of the present disclosure is stored in the aforementioned standard atmosphere until the yarn has attained its 13±1 wt % equilibrium moisture content in line with the standard atmosphere and therefore has reached a constant weight. This requires a 16 h conditioning time in the aforementioned standard atmosphere.

The textile data of the viscose multifilament yarn of the present disclosure, that is, yarn linear density, breaking strength, tenacity and elongation at break, are measured in accordance with DIN EN ISO 2062:2009 in the above-described conditioned state under the following conditions:
CRE tensile tester with pneumatic clamps [CRE: constant rate of specimen extension],
testing of multifilament yarns with a producer twist of 100 t/m (t/m=turns/meter),
clamped length of specimens: 500 mm
extension rate: 500 mm/min (100%/min).

The conditioning and testing conditions mentioned in the aforementioned standards are comparable to the pertinent standard of the manufactured fiber industry (BISFA “Testing methods for viscose, cupro, acetate, triacetate and lyocell filament yarns”, 2007 Edition) and the corresponding international standards (DIN EN ISO 6062, DIN EN 139, ASTM D885, ASTM D1776).

The crystallinity of the viscose multifilament yarn of the present disclosure is quantified by wide angle X-ray scattering (WAXS), as described in Hermans, P. H., Weidinger, A., Textil Research Journal 31 (1961) 558 to 571, wherein the values determined have an estimated maximum error of ±1.5% points.

In one preferred embodiment, the viscose multifilament yarn has a crystallinity in the range from 20% to 35%, a yarn linear density in the range of ≧170 dtex to <900 dtex, preferably in the range of ≧170 dtex to <850 dtex and a tenacity in the range of ≧45 cN/tex to ≦55 cN/tex.

In a particularly more preferable embodiment, the viscose multifilament yarn has a crystallinity in the range from 24% to 30%, a yarn linear density in the range of ≧200 dtex to ≦840 dtex, preferably in the range of ≧200 dtex to ≦820 dtex and a tenacity in the range of ≧48 cN/tex to ≦53 cN/tex.

In one preferred embodiment, the viscose multifilament yarn has a crystallite width in the range from 2.5 nm to 5.0 nm, more preferably in the range from 3.0 nm to 4.5 nm, and a crystallite height in the range from 9.0 nm to 13.0 nm, more preferably in the range from 10 nm to 12 nm. The crystallite width is determined from the reflection of the L(1-10) crystal plane, while the crystallite height is determined from the reflection of the L(004) crystal plane. High-strength cellulosic fibers spinnable from formaldehyde-modified viscoses/coagulation baths and correspondingly more stretchable exhibit distinctly larger L(004) reflections. Cordenka EHM®, a product which is no longer made, used to exhibit a crystallite height of 15.0 nm for example. [M. G. Northolt, H. Berstoel, H. Maatman, R. Huisman, J. Veurink, H. Elzterman, Polymer 2001, 42, 8249-8264.]

In one preferred embodiment, the viscose multifilament yarn has a birefringence Δn·10⁴ in the range from 300 to 450, more preferably in the range from 330 to 420. The birefringence Δn is measured using an interference microscope [J. Lenz, J. Schurz, D. Eichinger, Lenzinger Berichte 1994, 9, p. 21; P. H. Hermans, Contribution to the Physics of Cellulose Fibres, Chapter 7, Elsevier, Amsterdam, N.Y., 1946.]. For comparison, the birefringence Δn·10⁴ of the U.S. Pat. No. 3,388,117 viscose multifilament yarn produced using formaldehyde is in the range of >530 to 576 and thus distinctly higher.

It is advantageous for the fatigue resistance of a pneumatic vehicle tire utilizing the reinforcement ply of the present disclosure as a carcass ply when the viscose multifilament yarn has a filament linear density in the range of 1.2 and 4.0 dtex, preferably of 2.4 and 3.0 dtex.

In one preferred embodiment, the viscose multifilament yarn has an elongation at break in the range of ≧5% and ≦20%, preferably of ≧6% and ≦15%. A pneumatic vehicle tire containing such a reinforcement ply as carcass ply is more fatigue resistant, even under extreme conditions such as curbstone contacts.

The viscose multifilament yarn is a rayon multifilament yarn.

It is advantageous when the strength member is a textile cord consisting of at least two mutually folded viscose multifilament yarns, preferably arranged in the reinforcement ply in a density of 120 epdm to 280 epdm.

“epdm” is to be understood as meaning ends per decimeter and as describing the cord density in the reinforcement ply.

It is advantageous when the viscose multifilament yarns have a folding twist of 250 tpm to 650 tpm and when the textile cord has a cabling twist of 250 tpm to 650 tpm. The folding twist of the multifilament yarns may be S- or Z-directed, while the direction of the cabling twist is opposite to the direction of the folding twist for the multifilament yarns.

It has been found to be particularly useful to use reinforcement plies having textile cords formed from viscose multifilament yarn in the construction 620 dtex×2 in a density of 190 epdm or in the construction 780 dtex×2 in a density of 160 epdm, in either case with a filament linear density between 1.2 and 4.0 dtex, preferably between 2.4 and 3.0 dtex. The textile cords are very thin and have a very high level of fatigue resistance.

The viscose multifilament yarn is surprisingly obtained when the process described in Example 2 of GB 685,631 is modified in several technical features, as described hereinbelow. Formaldehyde is not used at any stage of the process according to the present disclosure.
Coniferous or deciduous (softwood or hardwood) pulps were used instead of cotton linters.
The viscose is admixed with viscose modifiers (for example, amine ethoxylates such as ethoxylated fatty acid amines or polyethylene glycols such as PEG 1500) in a concentration ranging from 0.01 to 1.0 wt % based on viscose prior to spinning.
The spinneret dies used have a hole diameter <100 μm, preferably in the range from 40 to 80 μm.
Spinning speed at the first takeup roll is less than 50 m/min and is preferably in the range from 10 to 40 m/min.
The thread is transported from the spinneret die into the coagulation bath through a spinning tube, the transportation of the thread in the spinning tube being augmented by a coagulation bath current in the direction of fiber takeoff.
Sulfuric acid concentration in the coagulation bath is greater than 15 g/liter and is preferably in the range from 20 to 120 g/liter.
Sodium sulfate and zinc sulfate are added to the coagulation bath, preferably in a concentration of 25 to 250 g/liter_{coagulation bath}.
Coagulation bath temperature is more than 30° C., but less than 100° C., and is preferably in the range from 40 to 95° C.
The subsequent fixing bath contains sulfuric acid, preferably in a concentration ranging from 20 to 120 g/liter_{fixing bath} and also serves as decomposition bath for cellulose xanthate.
The spun yarn is stretched to more than 175%, preferably the stretch is in the range from 180 to 220%.
The viscose multifilament yarn of the present disclosure is preferably produced in a two-step process wherein the yarn is spun and wound up in the first step and the wound-up yarn is unwound and washed in the second step.

Table 1 hereinbelow gives an exemplary overview of the viscose multifilament yarns used in the strength member ply of the present disclosure, with a conditioned yarn linear density of 204 dtex to 1013 dtex. The viscose multifilament yarns were obtained by the above-enumerated modifications to the production process described in Example 2 of GB 685 631 and conditioned in the DIN EN ISO 139-1:2005 standard atmosphere, that is, at a temperature of 20.0° C. and a relative humidity of 65%, and the textile data—yarn linear density, ultimate tensile force, tenacity and elongation at break were measured in the conditioned state in accordance with DIN EN ISO 2062:2009 under the conditions already described. In DIN EN ISO 2062:2009 the tenacity is referred to as fineness-specific ultimate tensile force and the elongation at break as ultimate tensile force extension.

Table 1 further includes, for some of the exemplary viscose multifilament yarns, values of the crystallinity determined by wide angle x-ray scattering (WAXS), values of the crystallite width determined from the reflection of the L(1-10) crystal plane and values of the crystallite height from the reflection of the L(004) crystal plane and a value of the Δn·10⁴ birefringence measured by interference microscopy.

TABLE 1

| | Example | | | | | | |
|---|---|---|---|---|---|---|---|
| Parameter | 1 | 2 | 3 | 4 | 5 | 6 | 7 |
| yarn linear | 204 | 425 | 640 | 643 | 801 | 815 | 1013 |
| density [dtex] | | | | | | | |
| filament count | 120 | 270 | 240 | 400 | 300 | 300 | 380 |
| ultimate tensile | 9.2 | 19.9 | 32.1 | 31.3 | 41.0 | 42.3 | 51.9 |
| force [N] | | | | | | | |
| tenacity | 45.0 | 46.8 | 50.2 | 48.6 | 51.2 | 52.0 | 51.4 |
| [cN/tex] | | | | | | | |
| elongation at | 6.1 | 7.7 | 9.2 | 8.5 | 9.7 | 9.2 | 10.1 |
| break [%] | | | | | | | |
| crystallinity [%] | — | — | 26.5 | — | — | 26.1 | — |
| crystallite width | — | — | 3.8 | — | — | 3.7 | — |
| [nm] | | | | | | | |
| crystallite | — | — | 11.3 | — | — | 11.0 | — |
| height [nm] | | | | | | | |
| birefringence | — | — | — | — | — | 390 | — |
| [Δn · 10⁴] | | | | | | | |

As mentioned, the tenacity of a selected number of individual filaments taken from a multifilament yarn is greater than the tenacity measured on the multifilament yarn. When 20 individual filaments of the viscose multifilament yarn of Example 3 are arbitrarily picked, conditioned and every one of the 20 individual filaments is measured as described above for the viscose multifilament yarn and the 20 individual filament values are averaged, this gives a tenacity of 60.4 cN/tex and an elongation at break of 11.8%. Therefore, tenacity and elongation at break as measured on the conditioned individual filaments are higher by 20% and 28%, respectively, than the corresponding values measured on the viscose multifilament yarn of Example 3.

Distinctly increased tenacities are measured in oven-dry yarn tests, that is, after 2 h drying of the viscose multifilament yarn at 105° C. and using the above-described settings for the tensile tester. Table 2 below shows the difference in textile data for the same yarn example which are obtained in conditioned (DIN EN ISO 139-1:2005) and, respectively, oven-dry measurements:

TABLE 2

| | Test conditions | |
|---|---|---|
| | Conditioning | |
| measured | >16 h at 20° C. and | Oven dry |
| parameters | 65% relative humidity | (2 h at 105° C.) |
| yarn linear density [dtex] | 646 | 560 |
| filament count | 240 | 240 |
| maximum tensile force [N] | 32.2 | 36.0 |
| tenacity [cN/tex] | 49.8 | 63.0 |
| elongation at break [%] | 8.6 | 8.2 |

As mentioned, the viscose multifilament yarn of the present disclosure has a yarn linear density in the range of ≧150 dtex to <1100 dtex, preferably of ≧170 dtex to <850 dtex and more preferably of ≧200 dtex to <820 dtex.

In a further preferred embodiment, the viscose multifilament yarns of the present disclosure have a yarn linear density in the range of ≧150 dtex to <1100 dtex or a yarn linear density in the range of ≧170 dtex to <850 dtex or a yarn linear density in the range of >200 dtex to <820 dtex and contain filaments having a filament linear density between 1.2 and 4.0 dtex or more preferably between 2.4 and 3.0 dtex. As a result, such viscose multifilament yarns of the present disclosure are not just useful for producing thin cords, but also yield cords of very high fatigue resistance. One example thereof is a high-strength viscose multifilament yarn of the present disclosure which has a conditioned yarn linear density of 800 dtex from 300 filaments (rayon 800 dtex f300).

The viscose multifilament yarn is converted into a woven fabric fit for calendering by performing the steps of
twisting the multifilament yarn(s) to obtain the desired strength member construction
producing a woven fabric containing the desired strength member
activating the woven fabric for rubber adherence, for example by means of an RFL dip
   which are known to a person skilled in the art.

Apart from that, the nature or makeup of the cellulosic fibers is not subject to any restrictions. The viscose multifilament yarn is accordingly processable as such or as short-cut fiber into a strength member, into a woven or knitted fabric. It is also possible to use the strength member containing the viscose multifilament yarn directly in the manufacture of a tire.

The problem addressed by this disclosure is solved in respect of the pneumatic vehicle tire when the latter comprises a rubberized reinforcement ply as described above.

The reinforcement ply therein is in particular a carcass and/or a belt bandage and/or a bead reinforcer.

In one preferred exemplary embodiment of the disclosure, the reinforcement ply is used as a carcass ply for pneumatic passenger car tires. The reinforcement ply is a rubberized woven fabric and comprises, by way of strength members, textile cords formed from two mutually cabled rayon multifilament yarns of the construction 620 dtex×2 in a density of 190 epdm. The multifilament yarns each have a folding twist of 600 tpm and the textile cord in question has a cabling twist of 600 tpm in the opposite direction of rotation. The filaments of each yarn have a filament linear density of 2.4 dtex. The breaking strength of any one rayon multifilament yarn is in the range of ≧45 cN/tex to ≦53 cN/tex. The viscose multifilament yarn has a crystallinity in the range from 15% to 40%. Every rayon multifilament yarn has an elongation at break in the range of ≧6% and ≦15%. Every rayon cord has a diameter of 0.42 mm, resulting in a thickness of 0.7 mm for the rubberized reinforcement ply.

In another preferred exemplary embodiment, the reinforcement ply is likewise used as a carcass ply for pneumatic passenger car tires. The reinforcement ply is a rubberized woven fabric which, by way of strength members, comprises textile cords formed from two mutually cabled rayon multifilament yarns of the construction 780 dtex×2 in a density of 160 epdm. The multifilament yarns each have a folding twist of 550 tpm and the textile cord in question has a cabling twist of 550 tpm in the opposite direction of rotation. The filaments of each yarn have a filament linear density of 3.0 dtex. The breaking strength of any one rayon multifilament yarn is in the range of ≧45 cN/tex to ≦53 cN/tex. The viscose multifilament yarn has a crystallinity in the range from 15% to 40%. Every rayon multifilament yarn has an elongation at break in the range of ≧6% and ≦15%. Every rayon cord has a diameter of 0.47 mm, resulting in a thickness of 0.75 mm for the rubberized reinforcement ply.

Table 3 hereinbelow gives an exemplary overview of the parameters of rayon textile cords of a certain construction.

TABLE 3

| | Example | | |
|---|---|---|---|
| Parameter | 1 | 2 | 3 |
| material | rayon | rayon | rayon |
| cord construction | 1840 dtex × 2 | 620 dtex × 2 | 780 dtex × 2 |
| cord linear density | 3900 | 1300 | 1620 |
| [dtex] (oven dry) | | | |
| filament count | 1000 | 240 | 300 |
| tenacity [cN/tex] | 46.2 | 50.8 | 53.7 |
| breaking strength [N] | 180 | 66 | 87 |
| (oven dry) | | | |
| elongation at break | 12 | 10 | 11 |
| [%] | | | |
| turns [tpm] | 420 | 600 | 550 |
| diameter [mm] | 0.72 | 0.42 | 0.47 |

### BRIEF DESCRIPTION OF THE DRAWINGS

The disclosure will now be described with reference to the drawings wherein:

FIG. 1 shows force-elongation curves for the rayon textile cords described in Table 3; and,

FIG. 2 shows force-elongation curves for three unrubberized woven fabrics in N/dm which each include one of the textile cords described in Table 4. “e” in the legend represents epdm.

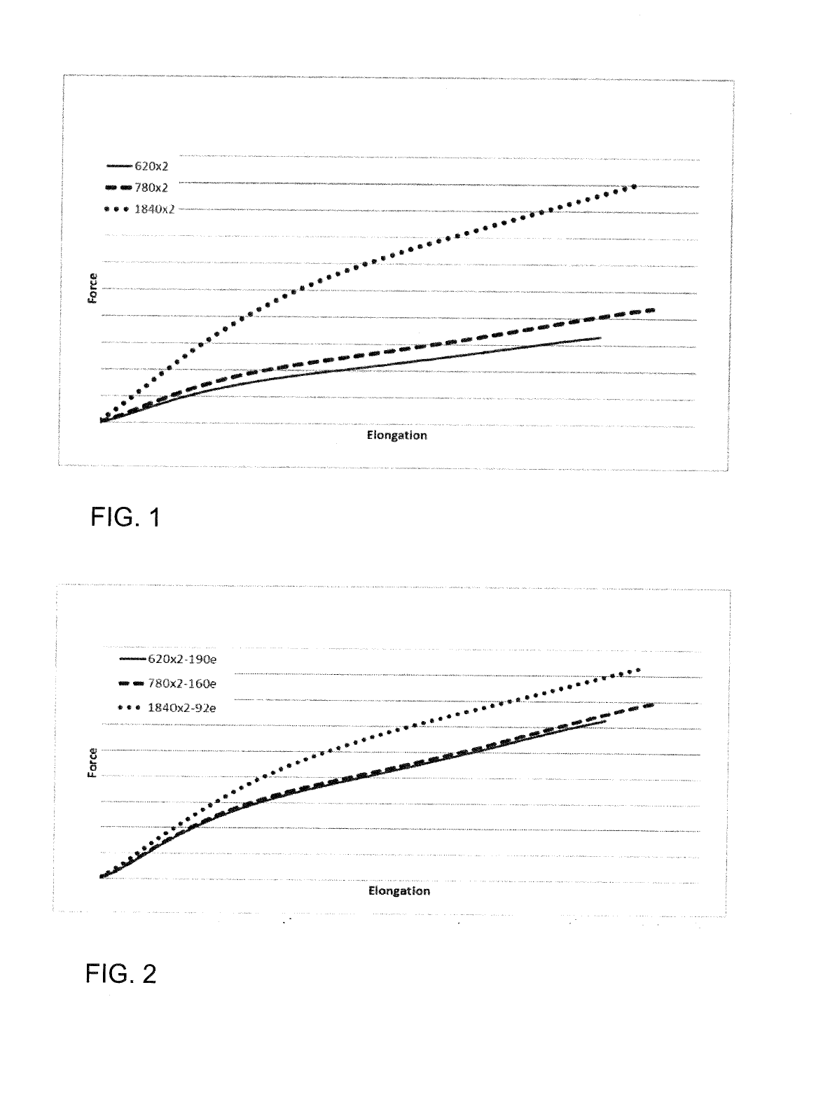

### DESCRIPTION OF THE PREFERRED EMBODIMENTS OF THE INVENTION

The force-elongation measurements were carried out in accordance with ASTM D885.

Table 4 hereinbelow gives an exemplary overview of a pneumatic passenger car tire which, by way of carcass, contains a woven fabric with rayon textile cords of a certain construction and a certain epdm, and also the rolling resistance obtained for the tire.

TABLE 4

| | Example | | |
|---|---|---|---|
| Parameter | 1 | 2 | 3 |
| material | rayon | rayon | rayon |
| construction | 1840 dtex × 2 | 620 dtex × 2 | 780 dtex × 2 |
| cord density [epdm] | 92 | 190 | 160 |
| rolling resistance [%] | 100 | 101.4 | 101.7 |

A rolling resistance of 100% corresponds to the reference. Rolling resistances >100% indicate a reduced (improved) rolling resistance, whereas rolling resistances <100% indicate an increased (worse) rolling resistance.

It is clearly seen that thin cords formed from rayon multifilament yarns have an improved rolling resistance despite higher cord density. Rayon multifilament cords are environmentally friendly because viscose is obtainable from renewable raw materials and is also processed/treated in an environmentally friendly manner.

It is understood that the foregoing description is that of the preferred embodiments of the invention and that various changes and modifications may be made thereto without departing from the spirit and scope of the invention as defined in the appended claims.

What is claimed is:

1. A rubberized reinforcement ply for articles made of an elastomeric material, the reinforcement ply comprising:
a multiplicity of mutually spaced-apart strength members in a parallel arrangement,
wherein every strength member includes at least one twisted viscose multifilament yarn, and
wherein the viscose multifilament yarn has a crystallinity in the range from 15% to 40% and after conditioning in a DIN EN ISO 139-1:2005 standard atmosphere has a yarn linear density in the range of ≧150 dtex to <1100 dtex and a tenacity in the range of ≧45 cN/tex to ≦55 cN/tex.

2. The reinforcement ply as claimed in claim 1, wherein the viscose multifilament yarn has a crystallinity in the range from 20% to 35%, a yarn linear density in the range of ≧170 dtex to <900 dtex, and a tenacity in the range of ≧45 cN/tex to ≦55 cN/tex.

3. The reinforcement ply as claimed in claim 2, wherein the viscose multifilament yarn has a crystallinity in the range from 24% to 30%, a yarn linear density in the range of ≧200 dtex to ≦840 dtex, and a tenacity in the range of ≧48 cN/tex to ≦53 cN/tex.

4. The reinforcement ply as claimed in claim 1, wherein the viscose multifilament yarn has a crystallite width in the range from 2.5 nm to 5 nm and a crystallite height in the range from 9 nm to 13 nm.

5. The reinforcement ply as claimed in claim 1, wherein the viscose multifilament yarn has a birefringence Δn·10⁴ in the range from 300 to 450.

6. The reinforcement ply as claimed in claim 1, wherein the viscose multifilament yarn has a filament linear density in the range of 1.2 and 4.0 dtex.

7. The reinforcement ply as claimed in claim 1, wherein the viscose multifilament yarn has an elongation at break in the range of ≧5% and ≦20%.

8. The reinforcement ply as claimed in claim 1, wherein the strength member is a textile cord having at least two mutually cabled multifilament yarns and in that the strength members are arranged in this reinforcement ply in a density of 120 epdm to 280 epdm.

9. The reinforcement ply as claimed in claim 8, wherein the multifilament yarns have a folding twist of 250 tpm to 650 tpm and the textile cord has a cabling twist of 250 tpm to 650 tpm.

10. The reinforcement ply as claimed in claim 8, wherein the textile cord has the construction 620 dtex×2 or the construction 780 dtex×2, and
wherein both yarns consist of viscose.

11. The reinforcement ply as claimed in claim 8, wherein the textile cord is asymmetrical and comprises multifilament yarns differing in yarn linear density and preferably comprises the construction 620 dtex×1/780 dtex×1 [600 tpm/550 tpm], wherein the direction of the cabling twist of the cord is opposite to the folding twist of the yarns.

12. A pneumatic vehicle tire comprising at least one reinforcement ply as claimed in claim 1.

13. The pneumatic vehicle tire as claimed in claim 12, wherein the reinforcement ply is a carcass and/or a belt bandage and/or a bead reinforcer.

14. The reinforcement ply as claimed in claim 2, wherein the viscose multifilament yarn has a yarn linear density in the range of ≧170 dtex to <850 dtex.

15. The reinforcement ply as claimed in claim 3, wherein the viscose multifilament yarn has a yarn linear density in the range of ≧200 dtex to ≦820 dtex.

16. The reinforcement ply as claimed in claim 6, wherein the viscose multifilament yarn has a filament linear density in the range of 2.4 and 3.0 dtex.

17. The reinforcement ply as claimed in claim 7, wherein the viscose multifilament yarn has an elongation at break in the range of ≧6% and ≦15%.
